(19) United States
(12) Patent Application Publication
(10) Pub. No.: US 2006/0058167 A1
(43) Pub. Date: Mar. 16, 2006

(54) Blood component separation system with stationary separation chamber

(76) Inventors: Michael Ragusa, Hingham, MA (US); Gary R. Stacey, Marshfield, MA (US); Etienne Pages, Segny (FR)

Correspondence Address: HAEMONETICS CORPORATION, 400 WOOD ROAD, BRAINTREE, MA, 02184-9114, US

(21) Appl. No.: 11/167,784

(22) Filed: Jun. 27, 2005

Related U.S. Application Data
(60) Provisional application No. 60/583,929, filed on Jun. 28, 2004.

(51) Int. Cl. B04B 11/02

(52) U.S. Cl. 494/5

(57) ABSTRACT

Provided is a blood processing system having a stationary component separation chamber. Individual blood components as well as other particles and contaminates are separated from blood flowing through the separation chamber by optical traps configured to manipulate specific components are projected into the flow field of the chamber. Cells or particles of the selected components that are manipulated by the optical traps then may be directed from the flow field to individual reservoirs to collect quantities of the selected components.

### FIELD OF THE INVENTION

The present invention relates to blood processing equipment. In particular, the invention pertains to systems and methods for the separation of one or more constituent components from blood using optical trapping projected through a stationary separation chamber.

### BACKGROUND OF THE INVENTION

Systems and processes for separating blood into its constituent components are well known. Commercial systems for rapidly processing large volumes of blood in a continuous flow process are available from Haemonetics Corporation of Braintree, Mass. In particular, equipment such as the MCS® line of equipment and Cell Saver ® 5 system available from Haemonetics are configured to receive blood directly from a patient or donor, transfer the blood to a blood processing chamber, separate components from the blood and direct those separated components to individual component reservoirs for later use or return to the patient while returning the remaining blood flow with the unseparated components back to the patient or donor in a continuous process.

The design of high-speed blood processing equipment such as the systems mentioned above is limited by several factors. The inherent biohazard presented by the presence of blood from different donors in the processing system requires that all surfaces and components contacted by the blood, the blood pathway, be economical and disposable in order for the system to be commercially feasible in servicing a plurality of donors or patients. Consequently, components that comprise the blood pathway in a blood processing machine, such as the separation chamber, component collection reservoirs and tubing that interconnects them and interfaces with the donor are made with inexpensive materials such as plastic so that they can be removed from the equipment after each collection procedure and replaced with new sterilized blood pathway components.

Separation of components from blood at high speeds compatible with a continuous flow process requires mechanical manipulation and movement of the separation chamber to actively separate the desired cells or particles from the liquid blood. Generally, centrifuge processes have been employed to accomplish such separation. In the prior art systems mentioned above, the separation chamber, once filled with blood from the donor is spun to apply centrifuge forces to the various cells and components in the blood. The varying mass of different components causes them to separate and form layers of like component structures. The layers appear as concentric rings in the spinning separation chamber. The separated component layers then may be withdrawn from the bowl to separate reservoirs. To accomplish effective centrifugation of the blood, separation chambers configured as a centrifuge bowl have been developed. However, reliably and economically maintaining a sterile fluid pathway with the moving centrifuge bowl has remained a challenge.

Approaches to maintaining a sterile connection between the spinning separation chamber and the rest of the blood pathway components have included incorporation of a rotating seal at the interface between the chamber and tubing that comprises the pathway such as that employed in the Latham Bowl manufactured by Haemonetics Corporation. Another approach involves using skip rope technology to avoid tangling of the pathway tubing that connects to the spinning separation chamber. However, both approaches add costs and complexity to disposable blood pathway sets which demand low cost pricing and extended reliability to remain commercially viable.

Alternative methods of separating blood into its constituent components that do not use centrifuge technology are available but have not been viable alternatives for a large scale blood separation operations. For example, cell sedimentation can be used to separate the various constituent components by the force of gravity. However, such processes are slow and require periods of stagnation of the blood, which increrases problems with coagulation.

It would be desirable to provide a high-speed blood component separation system that employs component separation technology that can be implemented easily in a separation chamber that is securely in communication with the sterile blood pathway of the system. Furthermore, it would be desirable to provide a system employing a separation technology that is highly effective, economical and reliable for a continuous flow process. It is among the objects of the present invention to provide such a system.

### SUMMARY OF THE INVENTION

The present invention provides a blood component separation system that uses optical trapping technology to separate constituent components of blood as it flows through a sterile blood pathway. The system may be configured to separate a single component from the blood or may separate multiple components, directing them to individual reservoirs for later use.

The system comprises an inlet to a blood pathway to receive blood from the blood stream of a patient or donor. The inlet may be joined to a single needle and configured to access the donor blood stream. The blood pathway may comprise tubing sized to permit flow of blood from the donor to the system. A draw pump configured to interact with the blood pathway drives blood flow from the inlet to a processing system at the necessary flow rate for separation of the blood components.

The processing system comprises a separation chamber in fluid communication with the blood pathway. The processing system further comprises optical elements configured to generate an optical trap such as a holographical optical trap projected into the blood flowing through the separation chamber. The separation chamber may remain stationary in the system while the optical trap projected into the blood pathway of the chamber operates to separate and move the components to their intended location for withdrawal from the blood pathway. The separation chamber is further configured not to interfere with the light energy generated by the optical elements, such as a laser, as it is transmitted into blood flowing through the chamber. Also, the separation chamber is configured to guide the flow of blood in a manner that is conducive to the optical trapping of components. The separation chamber further comprises one or more outlets into which the holographic optical trap directs individual components that have been separated from the blood. Each outlet is joined to a channel that is directed to a reservoir to hold the separated components.

After the one or more outlets, the blood pathway continues from the separation chamber through a conduit, such as tubing, to a return reservoir. The processed blood, with the separated components now removed, collects in the return reservoir until a predetermined quantity has been collected for return to the donor. When the predetermined quantity has been detected in the return reservoir, blood is withdrawn through an outlet in the reservoir through tubing by a return pump. From the return pump, the processed blood is directed back to the donor at a predetermined flow rate for blood return. The returning blood flows through the system inlet and back to the donor's blood stream through the single needle inserted into the donor.

The optical elements in the processing system should be configured to produce a holographical optical trapping array in the flow path of the separation chamber. The optical elements may include a light beam such as a laser, a diffractive optical element, a pair of lenses serving as a telescope, a dichroic mirror, which serves as a beam splitter and an objective lens. The details of how a holographic optical trap can be produced from the above listed elements, among others, and transmitted into a fluid flow to trap multiple particles is disclosed in U.S. Pat. Nos. 6,055,106 and 6,416,190 and U.S. patent application publication Nos. US 2003/0047676, US 2003/0119177, US 2004/0021949 and US 2004/0089798, the entirety of which are incorporated by reference herein.

In addition to the basic system outlined above, additional elements may be added to the system to optimize system performance for a given procedure. Anticoagulants may be introduced at the inlet of the system to, not only prevent coagulation of the blood in the pathway, but also to optimize the viscosity of the blood for the separation process. The anticoagulant may be introduced from a reservoir bag through a conduit such as tubing and its rate of flow controlled by an anticoagulant pump. Alternatively, other materials suitable for diluting blood may be used in place of anticoagulant, such as plasma or saline. In the case of a blood product such as plasma, it is preferable to use the patient's or donor's own plasma. Therefore, in such a system, plasma is one of the components separated by the system and the plasma reservoir is configured to have an outlet joined to a conduit that is selectively opened to the blood pathway to introduce the plasma.

The system may further be provided with a buffer reservoir of whole blood in communication with the blood pathway located before the processing system. Use of a buffer reservoir depends on the flow rate requirements for efficient processing of the blood versus maximum flow rates achievable into the system from the donor. If the processing system must operate at a flow rate that is less than the maximum achievable flow rate into the system from the donor, a buffer reservoir permits excess blood that is collected to be held temporarily and processed at a later time, such as when the system inlet is being used to return blood back to the donor and inflow is interrupted. A transfer pump drives blood through a conduit from the buffer reservoir to the processing system.

In another aspect of the invention, the optical trapping elements may be configured to additionally identify and separate from the blood pathogens or other harmful contaminants for the purpose of identifying the presence of such harmful elements in the blood sample. Although the harmful contaminants or pathogens would not be directed to a reservoir as a useful product, the separation chamber may be configured to provide an outlet and channel into which the contaminants are directed. A reservoir joined to the conduit then receives the contaminant and a sensor, such as an optical sensor, detects the presence of the contaminant in the reservoir. The sensor may be in communication with an alert system integrated as part of a system controller and user interface to notify the operator of the presence of the contaminant.

In another aspect of the invention, supplemental separation processes may be implemented in the system before or following the primary separation that occurs in the processing system. In particular, a conventional centrifuge-based component separation device may be connected in the blood pathway either before or after the processing system to remove a blood component such as red blood cells or plasma. Alternatively or in addition to the centrifuge-based separation device, a filter for separating contaminants from the blood may be added in the blood pathway either before or after the processing system.

In another aspect of the invention, the entire system may be employed in an autologous blood recovery setting to return blood components to a patient undergoing a medical procedure. A system for autologous blood recovery is configured similarly to the system described above except that the reservoirs for collection of the separated blood component are configured with return conduits that direct the sequestered component back to the patient connected to the system.

It is an object of the present invention to provide a blood processing system and method to separate constituent components from blood using optical trapping technology.

It is a further object of the invention to provide a blood component separation system and method using optical trapping that is suitable for both donations where blood components are collected for later use and for autologous blood recovery where blood is separated and separated components are returned to a patient.

It is another object of the invention to provide a system and method for identifying the presence of pathogens or contaminants in blood being collected from a patient or donor.

It is another object of the invention to provide a system and method for separating individual components from blood using optical trapping technology in combination with additional system separation processes involving centrifugation and/or filtering of the blood.

It is another aspect of the invention to provide a high-speed blood component separation system that uses a stationary separation chamber to reduce complexity, cost and risk of loss of sterility in the blood pathway.

### BRIEF DESCRIPTION OF THE DRAWINGS

The foregoing and other objects and advantages of the invention will be appreciated more fully from the following further description thereof, with reference to the accompanying diagrammatic drawings wherein:

FIG. 1 is a diagrammatic illustration of the blood separation system using optical trapping technology;

FIG. 2 is a diagrammatic detailed illustration of the processing system;

FIG. 3 is a diagrammatic illustration of the blood separation system using optical trapping including a buffer reservoir of whole blood before the processing system; and

FIG. 4 is a diagrammatic illustration of the blood separation system using optical trapping with the additional components of a blood centrifuge positioned before the processing system along the blood pathway and a blood filter located after the processing system along the pathway;

FIG. 5 is a diagrammatic illustration of an optical trap generation system;

FIG. 6 is a diagrammatic illustration of an optical trap generation system using a tilted optical element relative to an input light beam;

FIG. 7 is a diagrammatic illustration of a continuously translatable optical trap generation system;

FIG. 8 is a diagrammatic illustration of a holographic optical trap generation system;

FIG. 9 is a diagrammatic illustration of a holographic optical trap generation system.

### DESCRIPTION OF THE ILLUSTRATIVE EMBODIMENTS

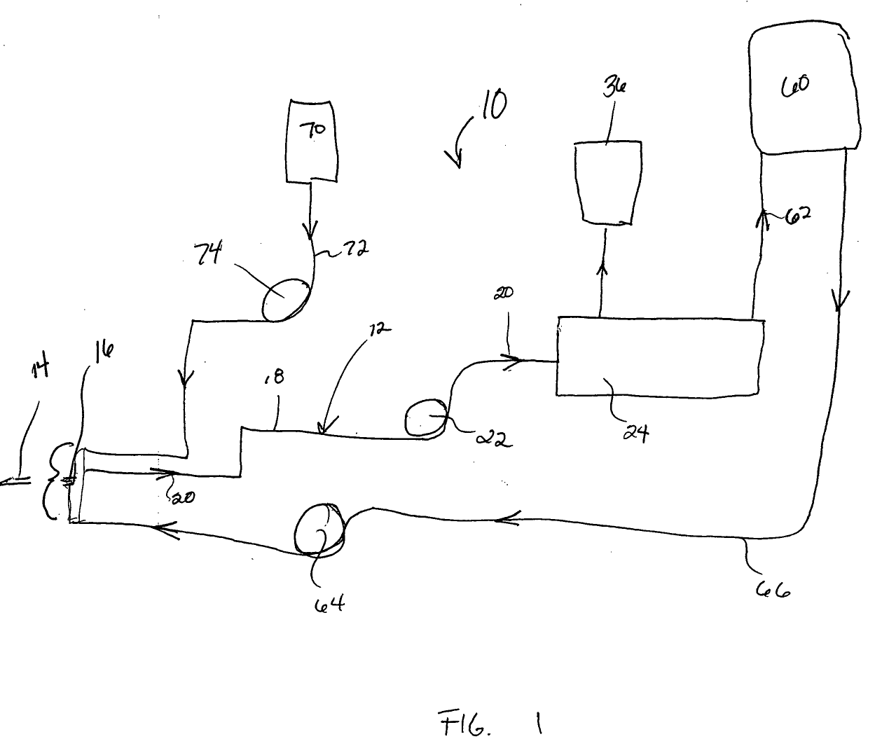

FIG. 1 shows a diagrammatic illustration of the components and configuration of a blood component separation system 10 using optical trapping technology. The system is configured to separate one or more constituent components from blood as it passes through the system. For example, the components separated may include red blood cells, plasma or platelet rich plasma. Additionally, optical traps may be configured to separate proteins, prions, viruses, bacteria and other contaminants and particles from the blood flowing through the system. In addition the optical trap may be configured to detect the presence of unique cells such as disease cells (e.g., sickle cells) or infected cells, the presence of which would cause a donated blood sample to be rejected. All the various components, cells, portions of cells, bacteria and contaminants are referred to generally in this application as “components”. It should be understood that reference to “components” can signify any one of the aforementioned elements found in blood as well and any other distinguishable component not mentioned in the above list.

As shown in FIG. 1, the system 10 comprises a blood pathway 12 through which blood travels from the patient or donor to the various components of the system. The blood pathway may comprise conventional conduits such as tubing that is economical, biocompatible and sterile. It is important that the blood pathway and all related connectors and reservoirs along the pathway remain sterile during the blood processing procedure to avoid danger to the patient or donor and to the collected and saved components that are intended for later use. The pathway is placed in communication with the blood stream of a patient or donor through a single needle 14 that connects to an inlet 16 of the pathway. The inlet may comprise a manifold configured to receive a plurality of tubes from the blood pathway to manage both the flow of blood into the pathway and the outflow of blood or blood components out of the pathway back to the patient or donor.

The inflow of blood enters the pathway from the patient and proceeds through inflow tube 18 as represented by inflow arrows 20. The rate of flow of the incoming blood is controlled by draw pump 22. The draw pump 22, as with all pumps discussed herein, may be a peristaltic pump acting on the exterior of the tubing to pump the blood in the tubing. The operation of each pump in the system may be electrically monitored and controlled by a central controller that also monitors the volume of blood or components in each reservoir. In this way, pump speed can be controlled to maintain ideal blood flow rates in each segment of the system to both maximize separation efficiency and minimize process time.

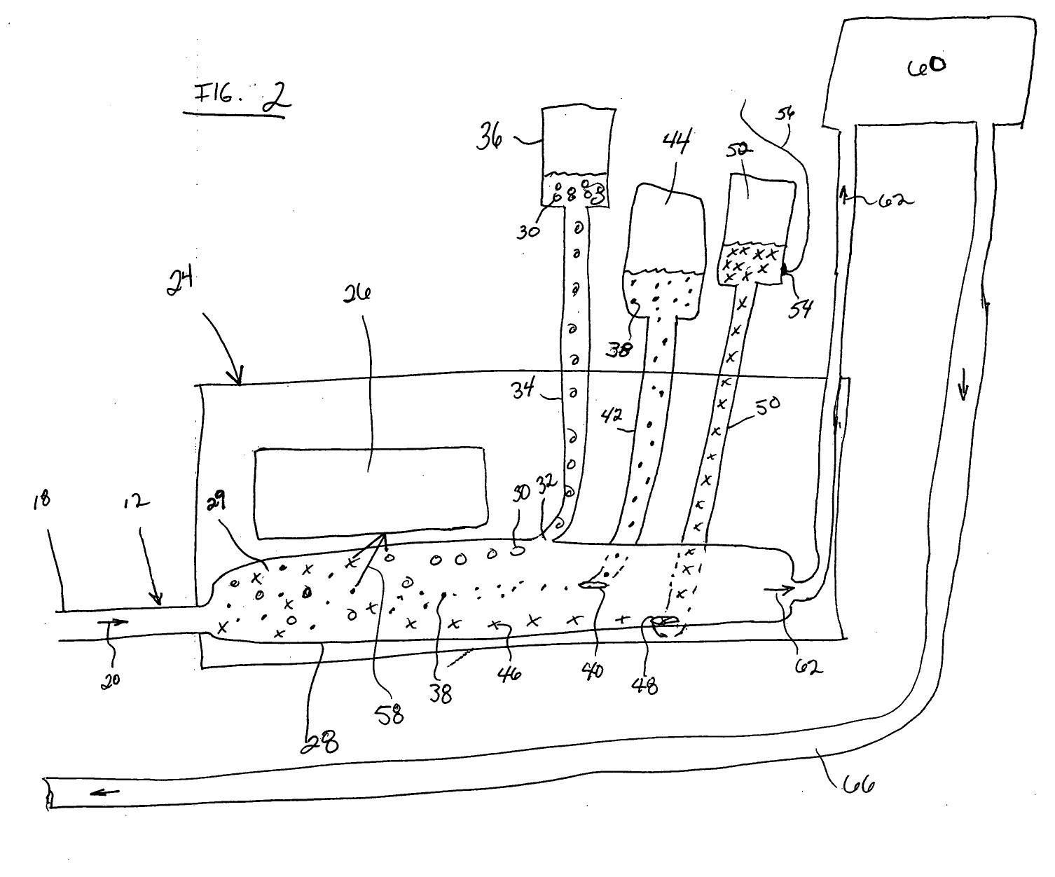

In a basic system, blood is drawn first into the processing system 24 is best seen in FIG. 2. The processing system 24 comprises an optical trap generation system 26 configured to project at least one optical trap into a separation chamber 28 that is in communication with the blood pathway 12. To capture and manipulate the numerous component particles that pass through a field of blood flow, such as the numerous amount of red blood cells that pass a given point in flow traveling at approximately 45 ml/min., a holographic optical trap is effective. As blood flows through the separation chamber, a holographic optical trap projected by the optical trap generation system serves to capture and manipulate numerous like component particles in the blood flow.

An advantage in separating components in the separation chamber using light energy in the form of an optical trap, is that the separation chamber can remain stationary while the light being projected into the chamber does all the work of separating components. Consequently, a complex mechanism for joining a moving separation chamber to the sterile blood pathway is not required as in centrifuge or skip-rope separation devices. The separation chamber of the present invention may remain stationary during separation and thus it can be easily, securably mounted in communication with the blood pathway, which makes it economical to manufacture and more reliable in maintaining sterility.

As shown in FIG. 2, as blood flows through the holographic optical trap projected into the separation chamber, targeted components that are predetermined to be captured by the optical trap are manipulated and directed to one or more outlets in the separation chamber. For illustration purposes, three types of components are shown being manipulated by light beams 58 in the separation chamber 28 shown in FIG. 2. Red blood cells are shown as circles 30 that are directed to outlet 32. The outlet is open to a channel 34 that leads to a red blood cell reservoir 36 such as a blood collection bag. Platelets are represented by black dots 38, which the holographic optical trap also has been configured to manipulate and direct to outlet 40, spaced from the red blood cell outlet 32. The outlet 40 opens to channel 42 that carries the platelets to reservoir 44. Diseased cells, such as sickle cells are represented by X's 46, the holographic optical trap having been configured to manipulate the specific type of disease cell in this example, directs the diseased cells 46 to a diseased cell outlet 48. The outlet 48 directs the diseased cells to a diseased cell channel 50 that carries the diseased cells to a diseased cell reservoir 52.

Because the diseased cells 46 are not to be reused, the purpose in identifying and separating them from the blood is to identify their presence in the blood sample. To alert the operator of the system of the presence of the diseased cells, a sensor 54, which may be an optical sensor, is configured to detect the presence of any diseased cells in the reservoir 52. The sensor may be connected to an operator alert by a wire 56.

It is reemphasized that the processing system may be configured to separate one component or plurality of components from blood passing through the separation chamber. In FIG. 1, an exemplary system configured to separate one component, such as red blood cells, is shown and the system is provided with one component reservoir 36. The detailed representation of the processing system shown in FIG. 2 illustrates another embodiment of the system in which a plurality of components have been separated from blood passing through the separation chamber, requiring a plurality of corresponding component reservoirs 36, 44 and 52. The exact configuration of the processing system and number and type of components that are separated by the holographic optical trap is flexible and can be tailored to meet the desired intended use of the system.

The optical trap generation system 26 comprises several optical elements necessary in generating a holographic optical trap including: a light beam such as a laser, an optical element, lenses to create a telescope, a dichroic mirror and an objective lens. The optical element may be a dynamic optical element that is computer controlled to vary the form of hologram. The operation of these elements to generate a holographic optical trap is discussed in detail in the patents and applications listed above and incorporated by reference in this application. The resulting holographic optical trap, represented in the figure by lines 58 emanating from the optical trap generation system 26 is projected into the field of blood flow through the separation chamber 28. The trap can be tailored to capture and manipulate one or more specific components in the blood based on the optical characteristics of those components. With a dynamic optical element, the holographic trap can be configured to move the captured components to the desired outlet by dynamically moving light beams of the trap to carry the components to the outlet. Alternatively, a static holographic optical trap, creates a static field of traps in the blood pathway of the separation chamber. As blood flows through that static field, each trap applies forces only to the selected components to cause them to flow in a direction to the selected outlet.

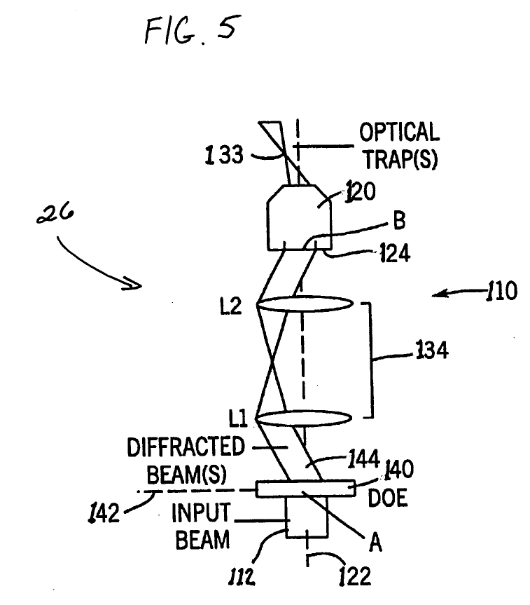

One possible configuration of the optical trap generation system 26, also known as an optical tweezer system, in which dynamic or arbitrary arrays can be formed is shown in FIGS. 5-7. The arrangement is described in U.S. Pat. No. 6,416,190, incorporated by reference above and from which the following description is taken. A diffractive optical element 140 is disposed substantially in a plane 142 conjugate to back aperture 124 of the objective lens 120. Note that only a single diffracted output beam 144 is shown for clarity, but it should be understood that a plurality of such beams 144 can be created by the diffractive optical element 140. The input light beam 112 incident on the diffractive optical element 140 is split into a pattern of the output beam 144 characteristic of the nature of the diffractive optical element 140, each of which emanates from the point A. Thus the output beams 144 also pass through the point B as a consequence of the downstream optical elements described hereinbefore.

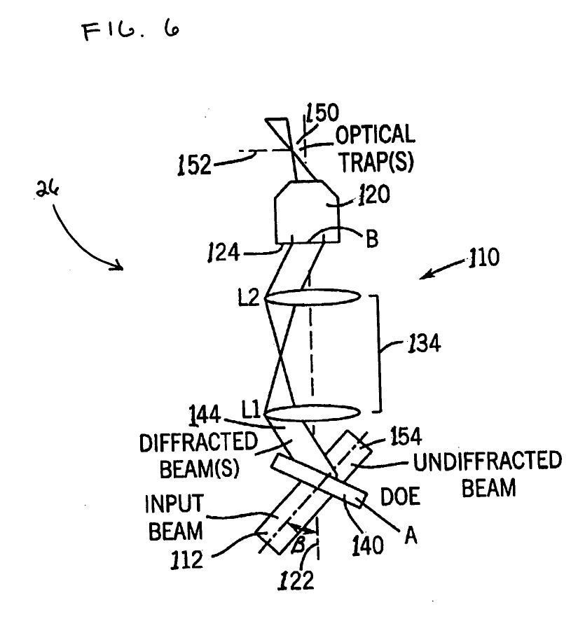

The diffractive optical element 140 of FIG. 5 is shown as being normal to the input light beam 112, but many other arrangements are possible. For example, in FIG. 6 the light beam 112 arrives at an oblique angle (beta) relative to the optic axis 122 and not at a normal to the diffractive optical element 140. In this embodiment, the diffracted beams 144 emanating from point A will form optical traps 150 in focal plane 152 of the imaging volume 132. In this arrangement of the optical tweezer system 110 an undiffracted portion 154 of the input light beam 112 can be removed from the optical tweezer system 110. This configuration thus enables processing less background light and improves efficiency and effectiveness of forming optical traps.

The diffractive optical element 140 can include computer generated holograms which split the input light beam 112 into a preselected desired pattern. Combining such holograms with the remainder of the optical elements in FIGS. 5 and 6 enables creation of arbitrary arrays in which the diffractive optical element 140 is used to shape the wavefront of each diffracted beam independently. Therefore, the optical traps 150 can be disposed not only in the focal plane 152 of the objective lens 120, but also out of the focal plane 152 to form a three-dimensional arrangement of the optical traps 150.

In the optical tweezer system 110 of FIGS. 5 and 6, also included is a focusing optical element, such as the objective lens 120 (or other like functionally equivalent optical device, such as a Fresnel lens) to converge the diffracted beam 144 to form the optical traps 150. Further, the telescope 134, or other equivalent transfer optics, creates a point A conjugate to the center point B of the previous back aperture 124. The diffractive optical element 140 is placed in a plane containing point A.

In another embodiment, arbitrary arrays of the optical traps 150 can be created without use of the telescope 134. In such an embodiment the diffractive optical element 140 can be placed directly in the plane containing point B.

In the optical tweezer system 110 either static or time dependent diffractive optical elements 140 can be used. For a dynamic, or time dependent version, one can create time changing arrays of the optical traps 150 which can be part of a system utilizing such a feature. In addition, these dynamic optical elements 140 can be used to actively move particles and matrix media relative to one another. For example, the diffractive optical element 140 can be a liquid crystal phase array undergoing changes imprinted with computer-generated holographic patterns.

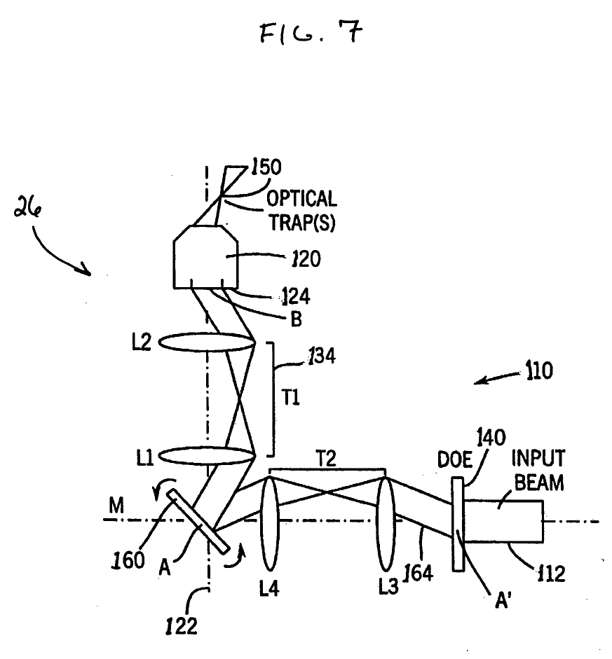

In another embodiment illustrated in FIG. 7, a system can be constructed to carry out continuous translation of the optical tweezer trap 150. A gimbal mounted mirror 160 is placed with its center of rotation at point A. The light beam 112 is incident on the surface of the mirror 160 and has its axis passing through point A and will be projected to the back aperture 124. Tilting of the mirror 160 causes a change of the angle of incidence of the light beam 112 relative to the mirror 160, and this feature can be used to translate the resulting optical trap 150. A second telescope 162 is formed from lenses L3 and L4 which creates a point A′ which is conjugate to point A. The diffractive optical element 140 placed at point A′ now creates a pattern of diffracted beams 164, each of which passes through point A to form one of the tweezer traps 150 in an array of the optical tweezers system 110.

In operation of the embodiment of FIG. 7, the mirror 160 translates the entire tweezer array as a unit. This methodology is useful for precisely aligning the optical tweezer array with a stationary substrate to dynamically stiffen the optical trap 150 through small-amplitude rapid oscillatory displacements, as well as for any application requiring a general translation capability.

The array of the optical traps 150 also can be translated vertically relative to the sample stage (not shown) by moving the sample stage or by adjusting the telescope 134. In addition, the optical tweezer array can also be translated laterally relative to the sample by moving the sample stage. This feature would be particularly useful for large scale movement beyond the range of the objective lens field of view.

Manipulation of cells in general, is made safer by having multiple beams available. Multiple tweezers ensure that less power is introduced at any particular spot in the cell. This eliminates hot spots and reduces the risk of damage. Any destructive two-photon processes benefit greatly since the absorption is proportional to the square of the laser power. Just adding a second tweezer decreases two-photon absorption in a particular spot by a factor of four. Putting the power into a single trap may cause immediate damage to the cell. The manipulation of even just a single cell is greatly enhanced by utilizing holographic optical trapping. Such a holographic optical trapping system, useable as the optical trap generation system 26 of the present invention, is described in U.S. patent application publication No. 2004/0089798, a description from which is provided below.

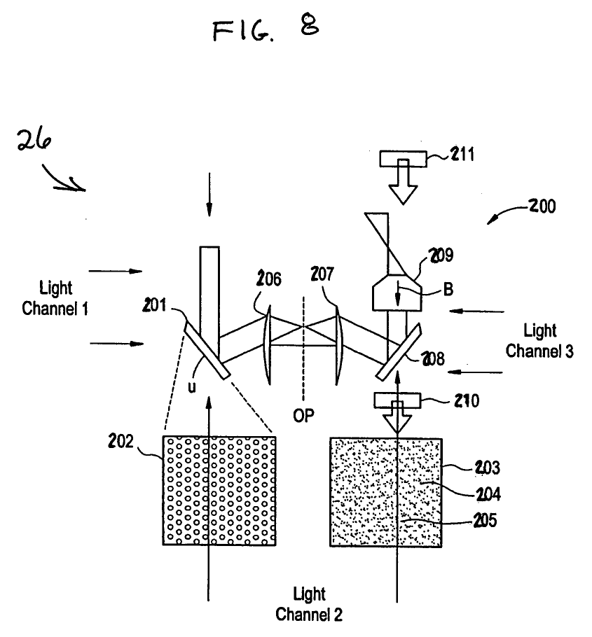

An optical trap generation system configured as a holographic optical trapping apparatus or system 200 is illustrated in FIG. 8. Light is incident from a laser system, and enters as shown by the downward arrow, to power the system 200. A phase patterning optical element 201 is preferably a dynamic optical element (DOE), with a dynamic surface, which is also a phase-only spatial light modulator (SLM) such as the “PAL-SLM series X7665,” manufactured by Hamamatsu of Japan, the “SLM 512SA7” or the “SLM 512SA15” both manufactured by Boulder Nonlinear Systems of Lafayette, Colo. These dynamic phase patterned optical elements 201 are computer-controlled to generate the beamlets by a hologram encoded in the medium which may be varied to generate the beamlets and select the form of the beamlets. A phase pattern 1-2 generated on the lower left of FIG. 8 produces the traps 203 shown in the lower right filled with 1 μm diameter silica spheres 204 suspended in water 205. Thus, the system 200 is controlled by the dynamic hologram shown below on the left.

The laser beam travels through lenses 206, 207, to dichroic mirror 208. The beam splitter 208 is constructed of a dichroic mirror, a photonic band gap mirror, omni directional mirror, or other similar device. The beam splitter 208 selectively reflects the wavelength of light used to form the optical traps 203 and transmits other wavelengths. The portion of light reflected from the area of the beam splitter 208 is then passed through an area of an encoded phase patterning optical element disposed substantially in a plane conjugate to a planar back aperture of a focusing (objective) lens 209.

The beam splitter 208 may be configured as a spatial light modulator which is essentially a liquid crystal array controlled by an electrostatic field which, in turn may be controlled by a computer program. The liquid crystal array has the property that it retards the phase of light by differing amounts depending upon the strength of the applied electric field. Nematic liquid crystal devices are used for displays or for applications where a large phase-only modulation depth is needed (2.pi. or greater). The nematic liquid crystal molecules usually lie parallel to the surface of the device giving the maximum retardance due to the birefringence of the liquid crystal. When an electric field is applied, the molecules tilt parallel to the electric field. As the voltage is increased the index of refraction along the extraordinary axis, and hence the birefringence, is effectively decreased causing a reduction in the retardance of the device.

Useful lasers include solid state lasers, diode pumped lasers, gas lasers, dye lasers, alexandrite lasers, free electron lasers, VCSEL lasers, diode lasers, Ti-Sapphire lasers, doped YAG lasers, doped YLF lasers, diode pumped YAG lasers, and flash lamp-pumped YAG lasers. Diode-pumped Nd:YAG lasers operating between 10 mW and 5 W are preferred. The preferred wavelengths of the laser beam used to form arrays for investigating biological material include the infrared, near infrared, visible red, green, and visible blue wavelengths, with wavelengths from about 400 nm to about 1060 nm being most preferred.

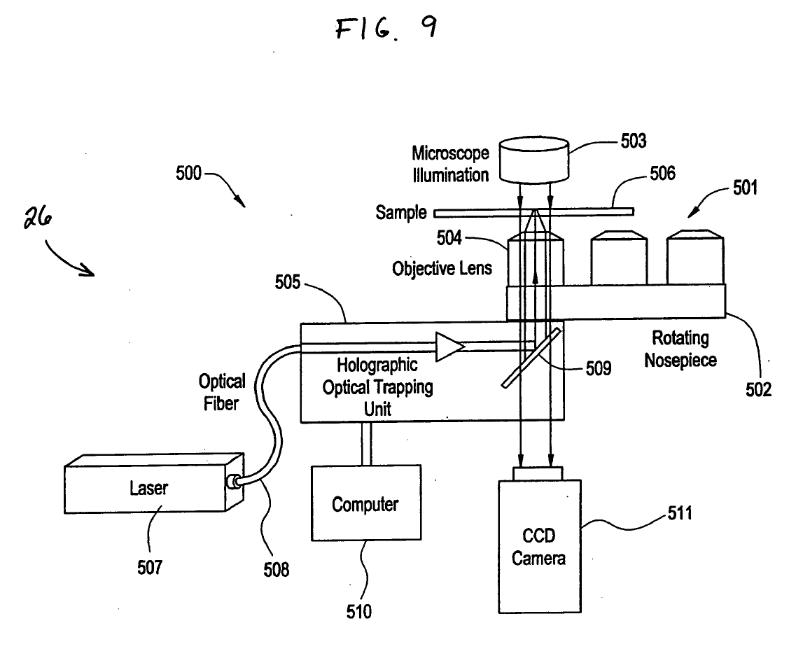

One configuration of the optical trap generation system 26 is an optical trapping system 500 shown in FIG. 9 (such as the BioRyx system sold by Arryx, Inc., Chicago, Ill.). It includes a Nixon TE 2000 series microscope 501 into which a mount for forming the optical traps using a holographic optical trapping unit 505 has been placed. The nosepiece 502 to which is attached a housing, fits directly into the microscope 501 via the mount. For imaging, an illumination source 503 is provided above the objective lens 504 to illuminate the sample 506.

The optical trap system 200 (see FIGS. 8 and 9) includes one end of the first light channel which is in close proximity to the optical element, and the other end of the first light channel which intersects with and communicates with a second light channel formed perpendicular thereto. The second light channel is formed within a base of a microscope lens mounting turret or “nosepiece”. The nosepiece is adapted to fit into a Nixon TE 200 series microscope. The second light channel communicates with a third light channel which is also perpendicular to the second light channel. The third light channel traverses from the top surface of the nosepiece through the base of the nosepiece and is parallel to an objective lens focusing lens 209. The focusing lens 209 has a top and a bottom forming a back aperture. Interposed in the third light channel between the second light channel and the back aperture of the focusing lens is a dichroic mirror beam splitter 208.

Other components within the optical trap system for forming the optical traps include a first mirror, which reflects the beamlets emanating from the phase patterning optical element 201 through the first light channel, a first set of transfer optics 206 disposed within the first light channel, aligned to receive the beamlets reflected by the first mirror, a second set of transfer optics 207 disposed within the first light channel, aligned to receive the beamlets passing through the first set of transfer lenses, and a second mirror 208, positioned at the intersection of the first light channel and the second light channel, aligned to reflect beamlets passing through the second set of transfer optics and through the third light channel.

Referring to FIG. 9, to generate the optical traps, a laser beam is directed from a laser 507 (see FIG. 5) through a collimator and through an optical fiber end 508 and reflected off the dynamic surface of the diffractive optical element 509. The beam of light exiting the collimator end of the optical fiber is diffracted by the dynamic surface of the diffractive optical element into a plurality of beamlets. The number, type and direction of each beamlet may be controlled and varied by altering the hologram encoded in the dynamic surface medium. The beamlets then reflect off the first mirror through the first set of transfer optics down the first light channel through the second set of transfer optics to the second mirror; and are directed at the dichroic mirror 509 up to the back aperture of the objective lens 504, are converged through the objective lens 504, thereby producing the optical gradient conditions necessary to form the optical traps. That portion of the light which is split through the dichroic mirror 509, for imaging, passes through the lower portion of the third light channel forming an optical data stream (see FIG. 8).

The separation chamber 28 of the blood component separation system should be configured to direct blood flow in a manner that is conducive to effective optical trapping of components based on the trapping force that will be available from the holographic optical trap. Furthermore, the separation chamber should be configured so that at least the side wall 29 facing the optical trap generation system and through which the optical trap is projected is transparent to the light form 58 being transmitted. The configuration of the separation chamber should be optimized to take advantage of the breadth of the holographic pattern that will be used. Furthermore, the separation chamber should be configured to promote consistent flow throughout its extent to limit variations in flow velocity during trapping in order to increase separation effectiveness. The inside surfaces of the separation chamber may be coated to resist coagulation of the blood to those surfaces, which could impede velocity of the blood adjacent the surfaces, creating a disparity in flow rate with the center of the chamber where flow remains high.

As shown in FIGS. 1 and 2, after blood containing the components not separated from it exits the separation chamber 28, it is directed through the blood pathway to a return reservoir 60 as indicated by flow arrow 62. Blood is collected in the return reservoir until a predetermined amount has been collected at which point return pump 64 draws the processed blood through return line 66 for discharge through the inlet 16 and through the needle 14 into the blood stream of the patient or donor.

Blood is collected and held in reservoir 60 after it has been processed and is returned in batches to the patient or donor to increase the processing efficiency of the system. Because withdrawal and return of blood to and from the patient or donor is accomplished through only one access point, the single needle 14, the time dedicated to inflow and return flow must be shared. This timesharing is accomplished by return of the processed blood in batches at high flow rates for brief periods. Therefore, the volume of processed blood maintained in reservoir 60 is monitored by a system controller and return pump 64 activated by the controller only when a predetermined volume has been collected to justify a brief interruption in inflow of blood. The draw pump 22 remains activated to continue pumping blood into the system even while the return pump is operated to send processed blood back to the donor or patient. During operation of both pumps, the flow rate out subtracted from the flow rate in yields the flow rate to or from the patient.

In another variation of the system, shown in FIGS. 1, 3 and 4, a reservoir of anticoagulant 70 may be joined to the blood pathway to selectively introduce anticoagulant as blood enters the system. The reservoir of anticoagulant 70 may be a flexible bag filled with an anticoagulant liquid joined to a conduit 72 that is connected to the manifold at the inlet 16 of the system. Anticoagulant is introduced into the system by operation of an anticoagulant pump 74 that can be selectively operated to introduce an amount of anticoagulant that corresponds to the desired ratio of anticoagulant to blood in order to optimize system performance. Typically, the ratio of anticoagulant added is dependent on the movement of the blood through the system. If there are many stagnant periods in the blood's flow through the system, more anticoagulant will be added to prevent coagulation of blood in the pathway.

With the optical trapping method of separation employed in the present system another factor becomes relevant in determining the correct ratio of anticoagulant. A ratio of anticoagulant should be added that creates an ideal viscosity of the blood passing through the separation chamber to effect efficient optical trapping. It is noted that adjusting the viscosity of the blood can also be accomplished by adding plasma or saline. The system employing an optical trapping method of separation may prove to be more continuously dynamic than conventional systems of separation, which would result in a reduction of the amount of anticoagulant necessary for maintaining fluid flow of the blood through the system.

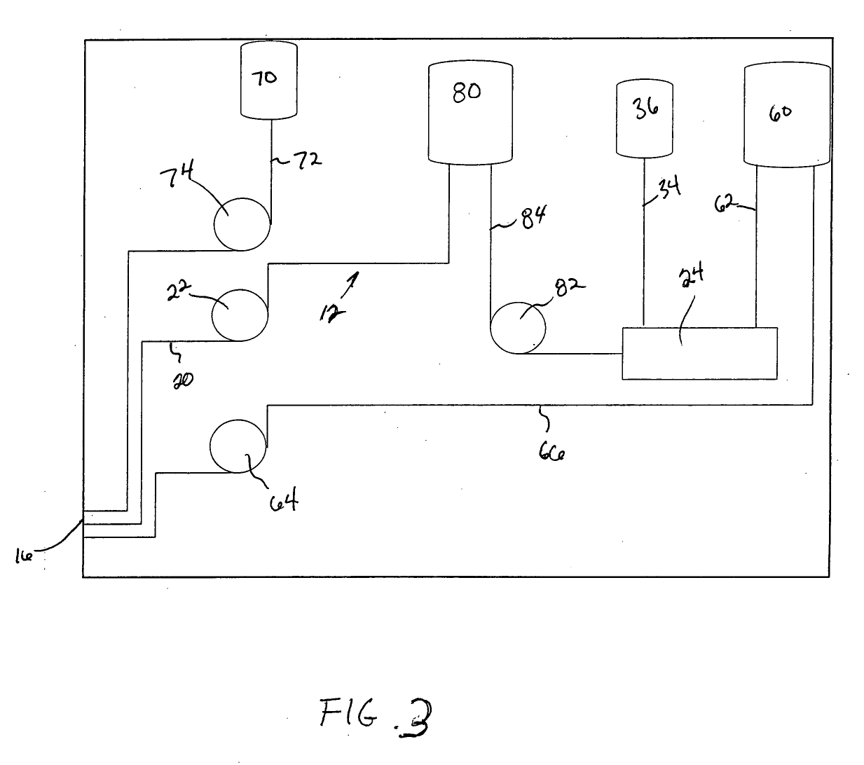

In another embodiment of the system as shown in FIG. 3, a buffer reservoir 80 containing whole blood drawn from the patient or donor is added to the system. The buffer reservoir serves as a holding station for blood initially drawn into the system by draw pump 22. If the processing system optimally separates components from blood at a blood flow rate that is less than the maximum draw flow rate of blood into the system, then blood must collect in the buffer reservoir until it can be processed.

Transfer pump 82 regulates the flow rate exiting the buffer reservoir 80 through transfer line 84. For example, if the maximum achievable input flow rate is 80 milliliters per minute but the separation of components from the blood taking place in the processing system is most effective at a flow rate of only 45 milliliters per minute, the transfer pump 82 must operate at a speed to regulate flow into the processing system at only 45 milliliters per minute. The faster flow of 80 milliliters per minute incoming to the system will backup in the buffer reservoir 80 to accommodate the required variation in flow rates in the system. The volume of blood collected in the buffer reservoir 80 is monitored either optically or by weight, and when it becomes filled, return pump 64 is activated and processed blood returned to the patient through single access point of the needle 14 connected to inlet 16. While the processed blood is flowing out of the inlet 16, the transfer pump 82 will continue to operate to process the blood stored in the buffer reservoir 80 to deplete the backlog. When the return reservoir 60 is drained, operation of return pump 64 is discontinued and the inlet is 16 is again receiving blood into the system from the patient or donor.

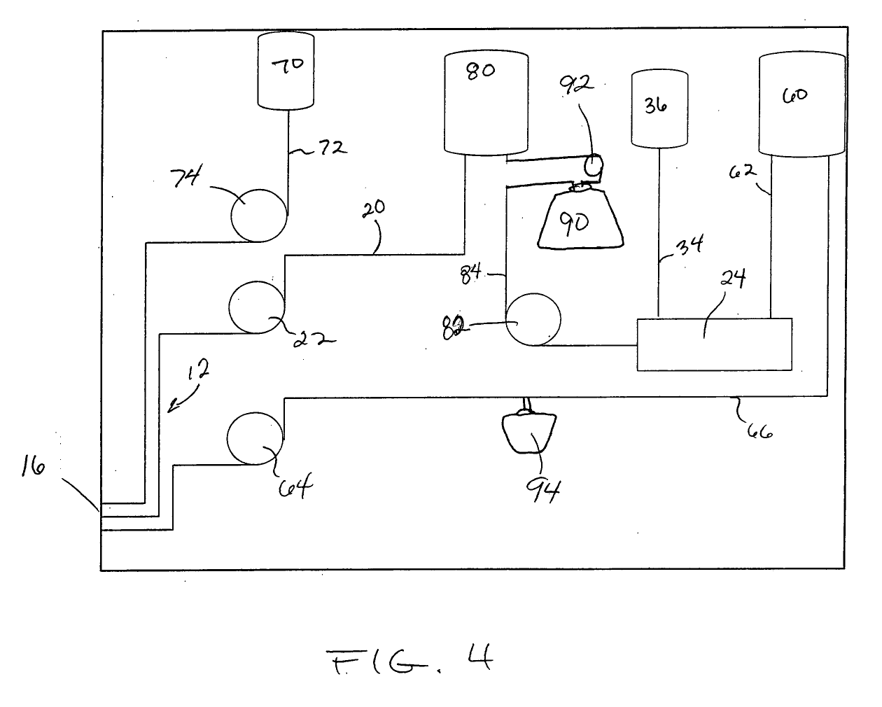

In another aspect of the invention, supplemental mechanisms for separating components from blood carried in the pathway 12 can be added to the system. As shown in FIG. 4, a centrifuge based separation chamber or bowl 90 can be added into the blood pathway 12 to perform a preliminary separation process prior to the main separation process that takes place in the processing system 24. The additional separation step can be used to preliminarily remove a component of the blood such as red blood cells reserving the optical trapping separation process for other discrete components still in the blood after the first separation step. In practice, the centrifuge bowl 90 may be connected in the fluid pathway after the buffer reservoir 80 and the blood drawn into the centrifuge bowl by centrifuge pump 92. The centrifuge bowl is spun mechanically by processing equipment well known in the art in order to separate blood components and direct the desired component to a directly connected to a component reservoir (not shown). The remaining blood components may then be transferred out of the centrifuge bowl by operation of transfer pump 82 and directed into the processing system for additional separation by optical trapping. Although the centrifuge bowl has been shown in the example of FIG. 4 as being located before the processing system, it may be located anywhere in the blood pathway such as after the blood processing system as blood returns to the patient or donor.

Another mechanism for providing an additional separation process in the system is the addition of a blood filter 94. The filter may be connected at any point in the blood pathway, either before or after the processing system. The filter can remove contaminants and particles from the blood based on their size and the pore size of the filter element.

In another aspect of the invention, the system may be configured for autologous blood recovery from a patient undergoing a medical procedure. In this situation, the system is configured similarly to the system discussed above. However, the component reservoirs such as for red blood cells or platelet rich plasma collected are configured to have return lines routed to return the component back to the patient that is connected to the system. The return lines are selectively opened and may be configured with pumps to move the collected component back to the patient.

It is noted that in the operation of the system discussed above that sensors to monitor the volume of blood in reach of the reservoirs should be used and linked electronically to a centralized control system that may include a controller. Also, linked to the control system are the several pumps so that their operation can be coordinated with information received on reservoir volumes in order to maintain operating efficiency of the system.

From the foregoing, a practical and effective blood component separation system using optical trapping technology to achieve separation has been presented. The system is capable of high speed component separation yet permits use of a stationary separation chamber that is economical to manufacture and reliable in use. It should It should be understood however, that the foregoing description of the invention is intended merely to be illustrative thereof and that other modifications, embodiments and equivalents may be apparent to those who are skilled in the art without departing from its spirit.

Having thus described the invention what we desire to claim and secure by Letters Patent is:

1. A blood component separation system comprising:
a blood pathway,
a processing system having
a separation chamber in communication with a blood pathway, optical trapping components including a light beam configured to project light into the separation chamber to effect separation of at least one component from blood flowing therethrough, the separation chamber being configured to create flow characteristics of blood traveling therethrough that are conducive to optical trapping,
at least one outlet in communication with the blood pathway and in communication with a component reservoir for collecting a separated component,
a draw pump upstream of the processing system to pump blood from a pathway inlet to the separation chamber of the processing system, and
a return reservoir in communication with the blood pathway downstream of the processing system and a return pump, downstream of the return reservoir for pumping blood with components left unseparated back to the inlet.

2. The blood component separation system as defined in claim 1 further comprising:
a buffer reservoir configured to contain whole blood in communication with the blood pathway and having an inlet receiving blood pumped from the draw pump and an outlet having blood drawn by a transfer pump directly to the separation chamber of the processing system.

3. The blood component separation system as defined in claim 1 further comprising:
a reservoir of anticoagulant, in communication with the blood pathway through a conduit joint at the inlet of the system and an anticoagulant pump configured to selectively pump anticoagulant through the conduit into the blood pathway at a predetermined rate.

4. A blood component separation system as defined in claim 1 further comprising:
an additional reservoir in communication with the separation chamber for receiving unique cells detected and separated and by the optical traps projected into the separation chamber; and
an optical sensor configured to observe the chamber and detect the presence of a predetermined unique cell and being connected to an operator alert.

5. A blood component separation system as defined in claim 1 further comprising:
a blood component separation centrifuge bowl in communication with the blood pathway and in communication with a component reservoir.

6. A blood component separation system as defined in claim 1 further comprising a blood filter in communication with the blood pathway.

7. A blood component separation system as defined in claim 1 wherein the blood component reservoir comprises an outlet in selective communication with the blood stream of a patient to return the separated component back to the patient's blood stream.

8. A high-speed blood separation system comprising:
a blood pathway,
a stationary separation chamber in communication with the blood pathway,
a component separation means configured to actively separate components in blood contained in the stationary separation chamber while remaining in communication with the blood pathway.

9. A method of processing blood to separate individual components from the blood comprising:
providing a blood component separation system comprising a blood pathway and a processing system having a separation chamber in communication with the blood pathway and optical elements to project optical traps into the separation chamber;
joining the blood pathway to a human blood stream;
causing blood to flow through the pathway and the separation chamber;
operating the optical elements to project an optical trap into blood flowing through the separation chamber;
separating at least one type of component from the blood and directing it to a component reservoir in communication with the blood pathway.
